(19) United States
(12) Patent Application Publication
(10) Pub. No.: US 2013/0080882 A1
(43) Pub. Date: Mar. 28, 2013

(54) METHOD FOR EXECUTING AN APPLICATION PROGRAM

(71) Applicant: Yu-Hui Cho, Hsinchu City (TW)

(72) Inventor: Yu-Hui Cho, Hsinchu City (TW)

(21) Appl. No.: 13/600,178

(22) Filed: Aug. 30, 2012

(30) Foreign Application Priority Data
Sep. 23, 2011 (TW) 100134424

(51) Int. Cl. G06F 3/048; G06F 17/00; G06F 3/041

(52) U.S. Cl. 715/251; 715/769

(57) ABSTRACT

A method for executing an application program is applied to an electronic device. A frame displayed by the electronic device includes a first icon, and the first icon corresponds to the application program. The method includes storing a first predetermined parameter corresponding to a first function of the application program; generating a first graph at a first location of the frame; dragging the first icon to overlap at least part of the first graph; comparing the first graph with the first predetermined parameter; starting the first function of the application program if the first graph matches the first predetermined parameter.

### BACKGROUND OF THE INVENTION

1. Field of the Invention

The present invention relates to a method for executing an application program, and particularly to a method that can quickly execute functions of an application program on a touch screen.

2. Description of the Prior Art

In the prior art, when a user wants to execute a specific function of an application program on a touch screen, the user needs to click an icon representing the application program displayed on the touch screen. Then, an operation system can execute the application program according to the icon displayed on the touch screen clicked by the user. When the application program is turned on, the user needs to touch specific functions icons within the application program displayed on the touch screen to execute the specific functions of the application program. That is to say, the user needs to perform a multi-step selection on the executed window interface to find proper function icons. Presently, although the prior art can create a batch file or provide quick turning-on method, new icons corresponding to the specific functions are still needed to build on the touch screen. Thus, the new icons may occupy large space of the frame, and the new icons sometimes confuse the user to correctly execute which icon.

Therefore, how to make the user operate the specific functions of a touch device through an interface of the touch device more easily becomes an important issue for a designer.

### SUMMARY OF THE INVENTION

An embodiment provides a method for executing an application program, the method is applied to an electronic device, a frame displayed by the electronic device includes a first icon, and the first icon corresponds to an application program. The method includes storing a first predetermined parameter corresponding to a first function of the application program; generating a first graph at a first location of the frame, where the first location does not include any icon; a method of generating the first graph is drawing the first graph by touching a touch screen if the electronic device has the touch screen; if the electronic device has a three-dimensional display method, a three-dimensional gesture can be utilized to draw a three-dimensional graph through the three-dimensional display method, where the three-dimensional graph can be acted as the first graph to perform the present invention; a user dragging the first icon to overlap at least part of the first graph; comparing the first graph with the first predetermined parameter; and starting the first function of the application program if the first graph matches the first predetermined parameter or the first graph matches an execution condition.

The present invention provides a method for executing an application program. The method can make a user quickly turn on an application program and execute a specific function. Therefore, compared to the prior art, the present invention can make a touch device friendlier, make all age users smoothly utilize the touch device, further keep icons displayed on the frame simplicity, and make the electronic device be operated more easily.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method for executing an application program according to an embodiment.

FIG. 2 is a diagram illustrating an electronic device.

FIG. 3 is a diagram illustrating the user dragging a first personal icon to the first location of the frame.

### DETAILED DESCRIPTION

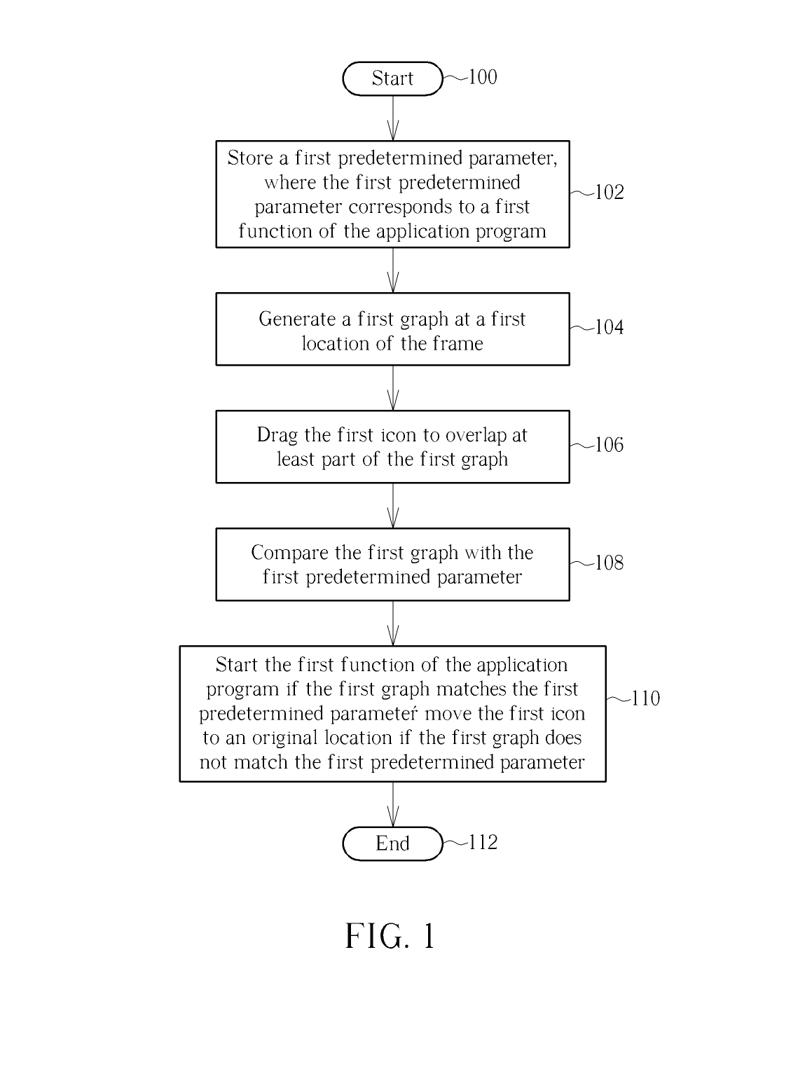

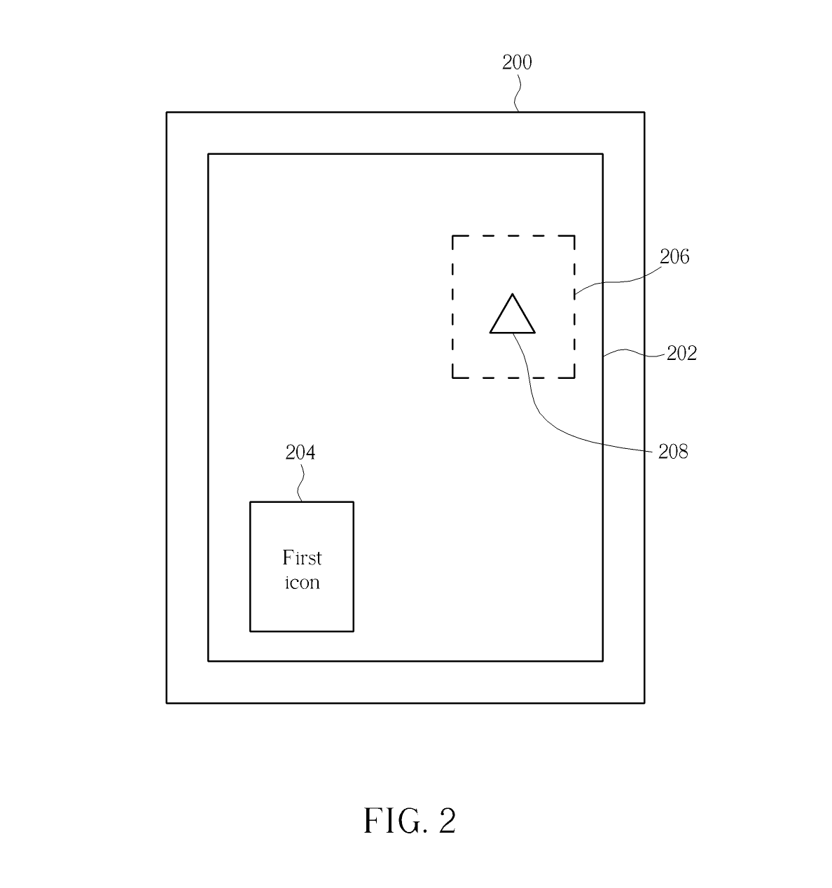

Please refer to FIG. 1 and FIG. 2. FIG. 1 is a flowchart illustrating a method for executing an application program according to an embodiment, and FIG. 2 is a diagram illustrating an electronic device 200. The method in FIG. 1 can be applied to the electronic device 200. As shown in FIG. 2, the electronic device 200 can be an electronic device having a display frame, e.g. a mobile phone, a tablet personal computer, an Industrial personal computer, and so on, which is applied to the present invention. A frame 202 displayed by the electronic device 200 includes a first icon 204, where the frame 202 is a frame of a touch screen, and a first icon 204 corresponding to an application program. For example, Microsoft Word, a multi-function computer, a browser, an electronic book program, and so on. Detailed Steps in FIG. 1 are as followed.

Step 100: Start.

Step 102: Store a first predetermined parameter, where the first predetermined parameter corresponds to a first function of the application program.

Step 104: Generate a first graph 208 at a first location 206 of the frame 202.

Step 106: Drag the first icon 204 to overlap at least part of the first graph 208.

Step 108: Compare the first graph 208 with the first predetermined parameter.

Step 110: Start the first function of the application program if the first graph 208 matches the first predetermined parameter; move the first icon 204 to an original location if the first graph 208 does not match the first predetermined parameter.

Step 112: End.

In Step 102, the first predetermined parameter can be a predetermined character group, a predetermined graph, or a plurality of predetermined values. The first predetermined parameter can be set according to a requirement of a user through a user interface (not shown), or first built in the application program during the application program being developed. In Step 104, the first location 206 (a rectangle) is located at a position where the frame 202 does not display any icon on. But, the first location 206 of the present invention is not limited to a rectangle. As shown in FIG. 2, the first graph 208 is a triangle, but the first graph 208 can also be a graph representing a number. For example, the first graph 208 can be a graph representing a number “5” . But, the present invention is not limited to the first graph 208 being the triangle or the number “5” . The first graph 208 can also be another character graph, a geometric graph, a user signature, or a value/predetermined graph displayed on a screen of the electronic device 200. In Step 106, the first icon 204 is dragged by the user to overlap at least part of the first graph 208, where to overlap the at least part of the first graph 208 means that the first icon 204 is touched an edge of the first graph 208 or the at least part of the first graph 208 is greater than a predetermined threshold. In Step 108, a processor of the electronic device 200 first executes identification on the first graph 208, where the identification can be “character identification” and “graph comparison”. When the first predetermined parameter is a character or a value, the processor of the electronic device 200 executes the “character identification”; when the first predetermined parameter is a geometric graph or a user signature, the processor of the electronic device 200 executes the “graph comparison”. Taking FIG. 2 as an example, the processor of the electronic device 200 identifies the first graph 208 as a first character. Then, the processor of the electronic device 200 compares the first character with the first predetermined character (the first predetermined parameter). In Step 110, when the first character matches the first predetermined character (the first predetermined parameter), the first function of the application program is started. The user may draw a second graph on the application program of the frame when the application program is started; comparing the second graph with a second predetermined parameter; and starting a second function of the application program if the second graph matches the second predetermined parameter.

In the embodiment of FIG. 1, the application program is a read program for reading an electronic book, where each page of the electronic book has a corresponding page number when the user reads the electronic book. When the first predetermined character is a page number, starting the first function of the application program (the read program) is the read program displaying a page of the electronic book having a corresponding page number according to a page number represented by the first predetermined character. For example, in the embodiment, the frame 202 is a content of a page number 5 of the electronic book displayed by the read program.

In another embodiment of the present invention, the application program is a music player for playing music. In the embodiment, when an identified number is number “5”, the first function can be playing the fifth album, the fifth song, or volume control 5 (the volume control range from 1-10), where the above mentioned function can be determined by the application program designer or the user.

In another embodiment of the present invention, an identified character is meaningful, or is a character with a predetermined function, such as “Uninstall”, “X”, or “XX” representing an uninstall program function. When Step 110 is executed, the application program corresponding to the first icon 204 is uninstalled. This character string having a meaning or a predetermined function can be preset to apply to any graph displayed by the electronic device 200 (e.g. a universal function) except being applied to the first icon 204.

In another embodiment of the present invention, in Step 102, the first predetermined parameter can be a first predetermined graph, and the predetermined graph is a signature corresponding to the user. In Step 104, a first graph 208 generated by the user at the first location 206 of the frame 202 can be a signature “John” . In Step 110, after the user drags the first icon 204 to overlap at least part of the first graph 208, the processor of the electronic device 200 executes a similarity comparison between the first graph 208 and the first predetermined graph (corresponding to the signature of the user). In Step 110, when a difference between the first graph 208 and the predetermined graph (corresponding to the signature of the user) is smaller than an error value, the first graph is determined to match the first predetermined parameter, and the first function of the application program is started according to a first usage parameter. That is to day, when the first graph 208 matches the signature corresponding to the user, the first usage parameter corresponding to the user starts the first function of the application program. In an electronic book embodiment, the application program can be a read program for reading an electronic book having page numbers, and the first usage parameter is a first page number displayed by the electronic book when the user turns off the read program previous time. Therefore, when the first graph 208 matches the signature corresponding to the user, the first function of the application program started according to the first usage parameter is displaying a page of the electronic book corresponding to the first page number. In addition, the first usage parameter corresponding to the user can also be set by the user to make the application program load the first usage parameter for a personalized usage when the application program is started, such as a color, a size of a character, a graph, or luminance, and so on.

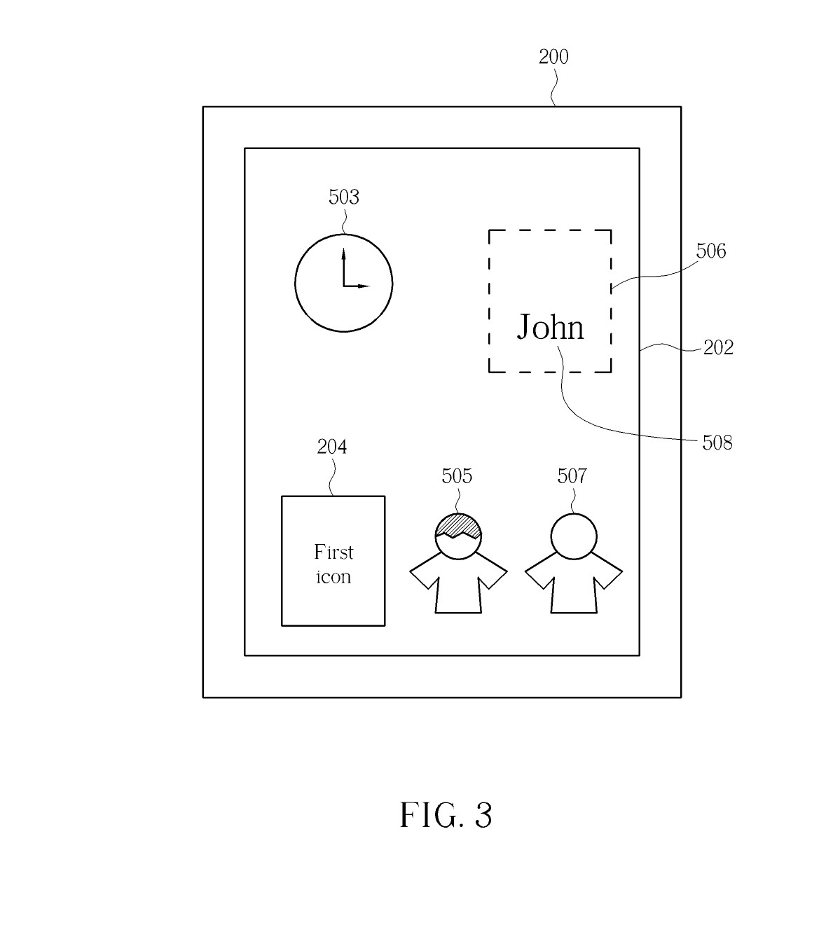

Please refer to FIG. 3. The frame 202 further displays a time icon 503, a first personal icon 507, and a second personal icon 505 except displaying the first icon 204. The time icon 503 displays time or a date of the electronic device 200, and the first personal icon 507 and the second personal icon 505 corresponds to an identification parameter of a first user and an identification parameter of a second user, respectively. In Step 104, as shown in FIG. 3, after the user drags the first personal icon 507 (corresponding to a figure icon of the first user) to a first location 506 of the frame 202 or the user double clicks the first personal icon 507, a first personal information 508 (e.g. a character “John”, a picture of John, a signature of John, and so on) can be displayed at the first location 506. Similarly, a corresponding result (e.g. a character “Mary”, a picture of Mary, a signature of Mary, and so on) can also be displayed at the first location 506 after the user operates the second personal icon 505. In Step 106, the first icon 204 is dragged to the first location 506 to overlap at least part of the first personal information 508 by the user, the application program corresponding to the first icon 204 can determine to utilize the first user parameter of John to execute a function of the application program according to the identification parameter (e.g. John) of the first user. Thus, the electronic device 200 can realize a personal purpose when John uses the electronic device 200.

For example, the application program can be a read program for reading an electronic book having page numbers or line numbers. The usage parameter of the user is a first page number, size of a character, luminance of a screen displayed by the electronic book when the user turns off the application program (the read program) previous time. Therefore, when John finishes utilizing the read program, the electronic device 200 can store a first page number (e.g. a page number 5), size of a character, luminance of the screen, and so on, and an identification code corresponding to John presently displayed by the electronic book. Therefore, as shown in FIG. 3, when the user drags the first icon 204 to the first location 506 to overlap at least part of the first personal information 508 to determine that the identification code corresponding to John matches an identification code corresponding to John stored in the application program (Step 110), the read program can display a page with the page number 5 according to setting stored in the electronic book before John turns off the electronic book previous time. According to the present invention, if Mary and John read the same electronic book on the electronic device 200, when the read program determines an identification code of Mary, the read program can display a corresponding page according to setting stored in the electronic book before Mary turns off the electronic book previous time. Thus, the present invention can solve different personal setting problem when different users utilize the same application program of the electronic device 200.

Please further refer to FIG. 3. In Step 104, after the user drags the time icon 503 to the first location 506 of the frame 202 or the user double clicks the time icon 503, present time information can be displayed at the first location 506. Meanwhile, the application program can be a time-related program. For example, a calendar or a work schedule. When the first icon 204 is dragged to the first location 506 to overlap at least part of the present time information, present corresponding time, corresponding work items, or a calendar can be displayed at the first location 506.

In another embodiment of the present invention, the application program corresponding to the first icon 204 can be a multi-function computer having functions of a calculator, a protractor and a ruler, where corresponding first predetermined graphs of the calculator, the protractor and the ruler are a predetermined square, a predetermined semi-circular, and a predetermined rectangle. In Step 104, if the first graph 208 generated at the first location 206 is a square, a semi-circular, or a rectangle, an inputted geometric graph can be compare with a predetermined geometric graph in Step 108. That is to say, a similarity comparison can be executed between the first graph 208 and the predetermined graph. When a difference between the first graph 208 and the predetermined graph is smaller than an error value, the application program determines that the first graph 208 matches the predetermined graph, and the functions of the calculator, the protractor and the ruler of the multiple computer program can be executed in Step 110.

To sum up, the method for executing an application program can make the user quickly turn on the application program and execute a specific function. Therefore, compared to the prior art, the present invention can make a touch device friendlier, and make all age users smoothly utilize a touch device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for executing an application program, the method being applied to an electronic device, a frame displayed by the electronic device comprising a first icon, the first icon corresponding to the application program, the method comprising:
storing a first predetermined parameter corresponding to a first function of the application program;
generating a first graph at a first location of the frame;
dragging the first icon to overlap at least part of the first graph;
comparing the first graph with the first predetermined parameter; and
starting the first function of the application program if the first graph matches the first predetermined parameter.

2. The method of claim 1, wherein the electronic device has a touch screen displaying the frame, the method further comprising:
drawing the first graph on the touch screen; and
dragging the first icon on the touch screen.

3. The method of claim 1, wherein, the first icon is moved in a three-dimensional display method when the electronic device displays the frame and the first icon, in the three-dimensional display method, the first graph is a three-dimensional graph.

4. The method of claim 1, wherein the first location is located at a position where the frame does not display any icon on.

5. The method of claim 1, wherein the first predetermined parameter is a first predetermined character, the method further comprising:
executing character identification on the first graph into a first character, and starting the first function of the application program if the first character matches the first predetermined character.

6. The method of claim 5, wherein the application program is a read program for reading an electronic book with page numbers, and the first predetermined character is a page number, wherein starting the first function is displaying a page of the electronic book according to the page number, wherein the page has a corresponding page number.

7. The method of claim 1, wherein the first predetermined parameter is a predetermined graph, the method further comprising:
executing a similarity comparison on the first graph and the predetermined graph, and starting the first function of the application program when a difference between the first graph and the predetermined graph is smaller than an error value.

8. The method of claim 7, wherein the first function is an uninstall function of the application program when the first graph is an “X” graph.

9. The method of claim 7, wherein the predetermined graph is a signature corresponding to a user, the method further comprising:
storing a first usage parameter of the user corresponding to the first function of the application program; and
starting the first function according to the first usage parameter when the first graph matches the signature.

10. The method of claim 9, wherein the application program is a read program for reading an electronic book having page numbers, the first usage parameter is a first page number displayed by the electronic book when the user turns off the read program previous time, and a page having the first page number of the electronic book is displayed when the first graph matches the signature.

11. The method of claim 1, wherein the frame further displays a second icon, the method further comprising:
executing the second icon to generate the first graph at the first location.

12. The method of claim 11, wherein when the second icon corresponds to an identification parameter of a user and the first predetermined parameter comprises the identification parameter of the user and a usage parameter of a user, the usage parameter of the user is utilized to execute the first function.

13. The method of claim 11, wherein a time parameter is utilized to execute the first function when the second icon corresponds to the time parameter.

14. The method of claim 7, wherein the first function is a ruler function of the application program when the first graph is a long bar.

15. The method of claim 7, wherein the first function is a calculator function of the application program when the first graph is a square.

16. The method of claim 7, wherein the first function is a protractor function of the application program when the first graph is a circle.

17. The method of claim 7, wherein the first function is a set square function of the application program when the first graph is a triangle.

18. The method of claim 1, further comprising:
drawing a second graph on the application program when the application program is started;
comparing the second graph with a second predetermined parameter; and
starting a second function of the application program if the second graph matches the second predetermined parameter.

19. A method for executing an application program, the method being applied to an electronic device, a frame displayed by the electronic device comprising a first icon, the first icon corresponding to the application program, the method comprising:
storing a first predetermined parameter corresponding to a first function of the application program;
generating a first graph at a first location of the frame;
dragging the first icon from a first position to overlap at least part of the first graph;
comparing the first graph with the first predetermined parameter; and
moving the first icon to the first position if the first graph does not match the first predetermined parameter.
